(19) United States
(12) Patent Application Publication
(10) Pub. No.: US 2017/0115952 A1
(43) Pub. Date: Apr. 27, 2017

(54) METHOD OF CONTROLLING A MOTOR VEHICLE ENTERTAINMENT SYSTEM

(71) Applicant: FORD GLOBAL TECHNOLOGIES, LLC, Dearborn, MI (US)

(72) Inventor: Jonathan GREGORY, Colchester Essex (GB)

(73) Assignee: FORD GLOBAL TECHNOLOGIES, LLC, Dearborn, MI (US)

(21) Appl. No.: 15/298,125

(22) Filed: Oct. 19, 2016

(30) Foreign Application Priority Data
Oct. 21, 2015 (GB) 1518663.8

(51) Int. Cl. G06F 3/16; G06F 17/30; B60R 21/015

(52) U.S. Cl. CPC G06F 3/16; B60R 21/01512; G06F 17/30772

(57) ABSTRACT

A method is disclosed of controlling a motor vehicle entertainment system based upon the occupancy of the motor vehicle. The occupancy of the motor vehicle is judged based upon inputs received from a number of seat sensors. The motor vehicle entertainment system includes a number of customised playlists based upon vehicle occupant identity. The motor vehicle entertainment system automatically selects a suitable playlist from the number of customised playlists based upon inferred identities of the occupants of the motor vehicle.

### CROSS-REFERENCE TO RELATED APPLICATIONS

This application claims foreign priority benefits under 35 U.S.C. §119(a)-(d) to GB 1518663.8 filed Oct. 21, 2015, which is hereby incorporated by reference in its entirety.

### TECHNICAL FIELD

This invention relates to motor vehicles and in particular to an entertainment system of a motor vehicle.

### BACKGROUND

It is known to provide a motor vehicle with an entertainment system (ICE) that allows audio content from a playlist to be played from at least one of a universal serial bus storage device (USB), a transportable media such as a compact disc, a hard drive of an entertainment unit forming part of an entertainment system or audio to be played from a radio station.

However, current motor vehicles require the driver or a passenger to manually select which radio station should be selected or which playlist should be played. If there are a number of different options available to a driver, then this can be distracting particularly when the motor vehicle is in motion.

It is an object of this invention to provide a method of controlling a motor vehicle entertainment system that operates in a substantially autonomous manner with little driver input.

### SUMMARY

According to a first aspect of the invention there is provided a method of controlling a motor vehicle entertainment system comprising establishing the identity of one or more occupants of the vehicle and selecting an audio output based upon the identity of the vehicle occupants.

Selecting an audio output based upon the identity of the vehicle occupants may comprise providing for one of the identified occupants of the vehicle a customized playlist specific to that occupant.

Selecting an audio output based upon the identity of the vehicle occupants may comprise automatically selecting for one of the identified occupants of the vehicle a customized playlist specific to that occupant and producing an audio output based upon the customized playlist.

Selecting an audio output based upon the identity of the vehicle occupants may comprise automatically selecting, for one of the identified occupants of the motor vehicle, a preferred radio station based upon previous use of the radio by the identified occupant and producing an audio output from the automatically selected radio station.

The entertainment system may include an entertainment unit having at least one memory device.

The method may further comprise saving for an identified occupant of the vehicle a customized playlist for the identified occupant.

The at least one customized playlist may be saved in the at least one memory device of the entertainment unit.

Establishing the identity of one or more occupants of the vehicle may comprise using at least one of a seat fore-aft position sensor and a seat mass sensor to establish characteristics of an occupant of a seat and saving the characteristics of the occupant of the seat as an occupant identity reference.

The occupant identity reference may be saved in the at least one memory device of the entertainment unit.

The method may comprise using at least one of a seat fore-aft position sensor and a seat mass sensor to establish the identity of a driver of the vehicle, selecting from a number of saved playlists a customized playlist based upon the identity of the driver and providing the driver of the vehicle with the customized playlist.

Alternatively, the method may comprise using at least one of a seat fore-aft position sensor and a seat mass sensor to establish the identity of a driver of the vehicle, automatically selecting from a number of saved playlists a customized playlist based upon the identity of the driver and automatically providing an audio output from the automatically selected customized playlist.

The entertainment system may include an entertainment unit having at least one memory device and the customized playlists are saved in the at least one memory device.

The method may comprise using at least one of a seat fore-aft position sensor and a seat mass sensor to establish the identity of a driver of the vehicle and automatically selecting a driver preferred radio station based upon previous use of the radio by the driver and producing an audio output from the automatically selected radio station.

The entertainment system may include an entertainment unit having at least one memory device and the identity of the driver preferred radio station may be saved in the at least one memory device.

According to a second aspect of the invention there is provided a motor vehicle entertainment system having an entertainment unit arranged to provide an audio output to at least one audio output device wherein the entertainment unit includes a programmable device arranged to establish based upon one or more sensor inputs the identity of one or more occupants of the vehicle and select an audio output based upon the identified vehicle occupants.

The sensor inputs may include an input from at least one of a seat fore-aft position sensor and a seat mass sensor.

According to a third aspect of the invention there is provided a motor vehicle having an entertainment system constructed in accordance with said second aspect of the invention.

A seat for a driver of the motor vehicle may include a seat fore-aft position sensor and a seat mass sensor and the identity of the driver may be established based upon the outputs from the seat fore-aft position and mass sensors.

The invention will now be described by way of example with reference to the accompanying drawing of which:—

### BRIEF DESCRIPTION OF THE DRAWINGS

FIG. 1 is a schematic plan view of a motor vehicle in accordance with a third aspect of the invention having an entertainment system constructed in accordance with a second aspect of the invention;

FIG. 2 is a block diagram showing the main components of the entertainment system shown in FIG. 1; and

FIG. 3 is a high level flow chart of a method of controlling a motor vehicle entertainment system in accordance with a first aspect of the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

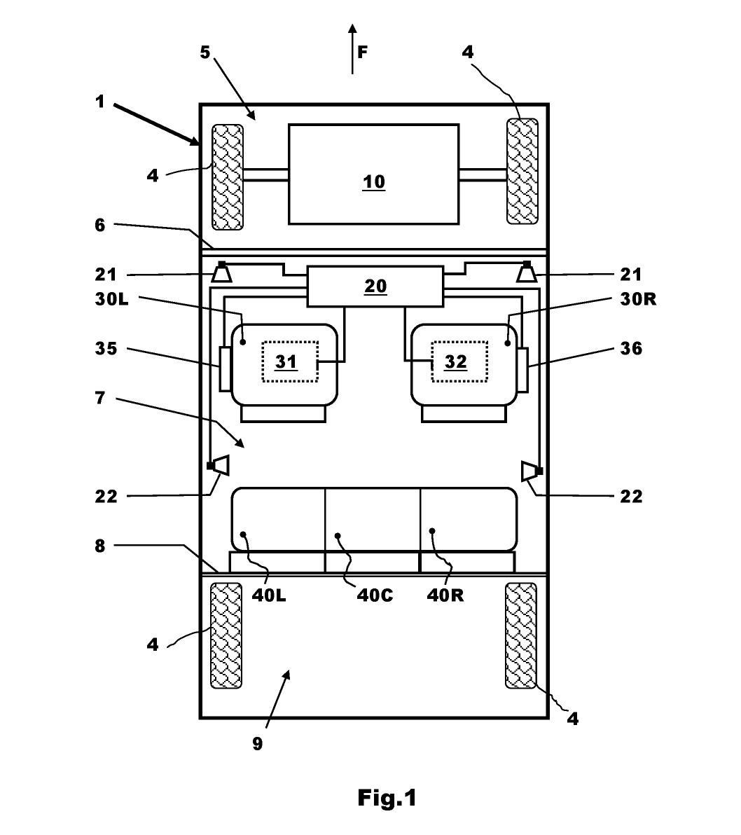

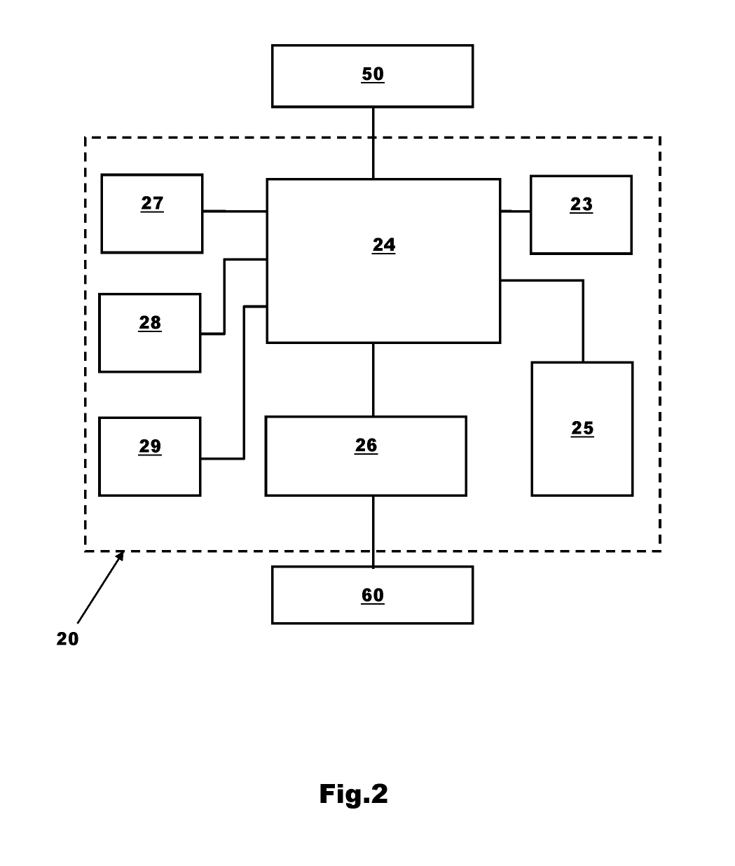

Referring to FIGS. 1 and 2 there is shown a motor vehicle 1 having four road wheels 4, an engine compartment 5, a passenger compartment 7 separated from the engine compartment 5 by a front firewall 6, a luggage compartment 9 separated from the passenger compartment 7 by a rear firewall 8, left and right front seats 30L, 30R mounted in the passenger compartment 7 for use by occupants of the motor vehicle 1, a row of rear seats 40L, 40C, 40R mounted in the passenger compartment 7 for use by occupants of the motor vehicle 1 and an entertainment system including an entertainment unit 20 and a number of speaker 21, 22.

An engine and multispeed transmission assembly 10 is mounted in the engine compartment 5 and is arranged to drive the front road wheels 4 of the motor vehicle 1. A forward direction of travel of the motor vehicle 1 is indicated by the arrow ‘F’ on FIG. 1

The motor vehicle entertainment system is arranged to selectively provide audio to occupants of the passenger compartment 7.

The entertainment system comprises the entertainment unit 20 and a number of audio output devices in the form of front and rear speakers 21 and 22 respectively. It will be appreciated that there could be more or less speakers than the four shown in FIG. 1.

The entertainment unit 20 comprises in the case of this example a programmable device in the form of a central processing unit 24, a human machine interface 23 (HMI 23) a memory device 25, an amplifier 26, an transportable media input unit 27 for accepting a transportable media such as a compact disc (not shown), a radio 28 and a universal serial bus socket 29 for accepting a transportable USB device (not shown). The HMI 23, the memory device 25, the amplifier 26, the media input unit 27, the radio 28 and the universal serial bus socket 29 are all operatively connected to the central processor unit 24 which manages the flow of information, signals and data between the various components of the entertainment unit 20 and is programmed to perform a number of tasks as described hereinafter. It will be appreciated that although the entertainment unit 20 is shown as a single unit in FIGS. 1 and 2 it could in practice comprise of several units or modules that are operatively linked together.

It will further be appreciated that the memory device 25 can be in the form of a solid state memory device, a hard drive storage device or a combination of both types of memory device. In the case where the memory device is a solid state device there may be a number of separate solid state memory devices that form in combination the memory device 25 or the memory device 25 could comprise a single large memory device.

Irrespective of the type of memory used to form the memory device 25, the memory device 25 is arranged to store a number of customized playlists specific to previously identified vehicle occupants referenced by vehicle occupant.

The memory device 25 in this case also retains data (occupant identity references) relating to various previous frequent users of the motor vehicle from which the identity of an occupant can be inferred. The occupant identity references are used to decide which of the various customized playlists is relevant to the current occupancy of the motor vehicle 1.

The central control unit 24 is arranged to receive an input 50 indicative of the occupancy of the motor vehicle 1 that is used to evaluate the most suitable playlist for the current occupancy of the motor vehicle 1.

In the case of this example the input 50 comprises signals from a number of seat sensors 31, 32, 35 and 36.

The front left hand seat 30L is in the case of this example a seat for a driver of the motor vehicle 1 and has a mass sensor 31 to sense the weight of an occupant of the seat 30L and a seat position sensor in the form of a seat track position sensor 35 to sense the fore-aft position of the seat 30L.

The front right hand passenger seat 30R has a mass sensor 31 to sense the weight of an occupant of the seat 30R and a seat position sensor in the form of a seat track position sensor 36 to sense the fore-aft position of the seat 30R.

The amplifier 26 is connected to an output 60 that in the case of this example comprises the front and rear speakers 21 and 22.

The central control unit 24 is operable to automatically select a customized playlist based upon occupancy from the customized playlists stored in the memory device 25 unless an occupant has manually selected another input source by, for example, selecting a radio station, inserting a compact disc into the media input device 27, connecting a bluetooth or otherwise wireless device to the media input device 27 or inserting a USB device into the universal serial bus socket 29. Any of these manual actions by an occupant will cause the entertainment unit 20 to provide the occupants of the motor vehicle 1 with an audio output based upon the manually selected input source.

The entertainment unit 21 is also operable to prompt to determine whether the audio content from the manually selected input source should be saved in the memory device 25 in one of the customized playlists based upon the identity of the occupant who has selected the audio source.

In the case where the radio has been manually selected, a reference indicating the selected station is saved in the memory device along with a reference indicating the identity of the occupant.

The storage of such information is referenced by current occupancy and so, for example, if only a driver is present in the motor vehicle 1 then it will be referenced as a specific driver (driver identity) relevant playlist or radio selection. The identity of the driver is established or inferred based upon the weight of the driver sensed by load sensor 31 and the fore-aft position of the seat 30L as sensed by the seat position sensor 35.

If there is a driver and a front seat passenger then the entertainment unit 20 provides a prompt asking whether the audio is to be referenced based upon the driver or the front seat passenger. The response is input to the entertainment unit 20 by one of the occupants via the HMI 23. If the audio is to be referenced based upon the current passenger then the identity of the passenger is established or inferred based upon the weight of the passenger sensed by the mass sensor 32 and the fore-aft position of the seat 30R as sensed by the seat position sensor 36.

It will be appreciated that the above description is based upon a left hand drive vehicle but the same approach can be used if the vehicle is a right hand drive vehicle.

If there is no manual selection of an input source the entertainment unit 20 is operable to automatically provide the occupants with an audio output based upon the occupancy of the motor vehicle 1.

If only a driver is present in the motor vehicle 1, then the customized playlist or radio station automatically selected by the entertainment unit 20 will be one that has previously been saved referenced against the current driver. The identity of the driver is established or inferred as before based upon the weight of the driver sensed by the mass sensor 31 and the fore-aft position of the seat 30L sensed by the seat position sensor 35 along with the occupant identity references saved in the memory device 25.

The selected customized playlist or preferred radio station can either be automatically provided as an output to the speakers 21, 22 or the entertainment unit 20 can provide a prompt asking whether audio from the playlist or from the radio station is to be output. In some embodiments the entertainment unit has radio and saved music modes and when the entertainment is in the radio mode audio is provided to the speakers 21, 22 from the entertainment unit from the preferred radio station and when the entertainment is in the saved music mode the customized playlist is provided to the speakers 21, 22 or the occupants can be provided with a prompt to select one or more items from the customized playlist.

If there is a driver and a front seat passenger then the entertainment unit 20 provides a prompt asking whether the audio is to be selected based upon the driver or the front seat passenger. The response is input to the entertainment unit 20 by one of the occupants via the HMI 23. If the audio is to be selected based upon the current passenger, the identity of the passenger is established or inferred based upon the weight of the passenger sensed by the mass sensor 32 and the fore-aft position of the seat 30R as sensed by the seat position sensor 36.

It will be appreciated that the above description is based upon a left hand drive vehicle but the same approach can be used if the vehicle is a right hand drive vehicle.

In some cases a composite playlist comprised of items from a customized playlist for the driver and a customized playlist for the passenger can be provided from which an audio output can be manually selected or in some cases automatically selected.

It will be appreciated that a key aspect of the invention is the identifying and saving of details regarding the various users of the motor vehicle 1 that can be used to select an appropriate customized playlist containing audio specific to the occupant currently requiring an audio output.

In order to achieve this, various customized playlists are saved, each of which is specific to a particular user and which are given a unique identity based upon the weight of the occupant and the seat position chosen when the occupant occupies one of the front seats 30L, 30R.

Table 1 below provides one non-limiting example of the manner in which various occupants differ enabling their identities to be inferred based upon seat position and weight. It will be appreciated that there could be more than five occupant identities saved for reference by the entertainment unit 20.

In the example given below in Table 1 the furthest forward position of each of the front seats 30L, 30R is assigned a value of zero as part of the calibration of the seat position sensors 35, 36. The value of seat position provided in Table 1 is a calibrated value indicative of the distance as measured by one of the seat position sensors 35, 36 that the respective front seat 30R, 30L is displaced rearwardly from its respective zero position.

TABLE 1

| Occupant Identity | | |
|---|---|---|
| Reference | Weight kg | Seat Position |
| A | 80 | 250 |
| B | 60 | 150 |
| C | 65 | 150 |
| D | 60 | 100 |
| E | 45 | 0 |

It will be noted that the occupants B and D weigh the same but they can be differentiated between because their chosen seat positions differ. Similarly, the occupants B and C have the same chosen seat positions but they can be differentiated between because their weights are different.

Therefore unique identities can be assigned for various occupants of the motor vehicle 1 over time for use in controlling the entertainment system.

Each of the customized playlists is assigned one of the occupant identity reference values and so when an occupant matches the weight and seat position characteristics given in Table 1 the entertainment unit 20 knows which customized playlist to select.

The audio output from the speakers 21, 22 is automatically selected based upon the identities of the occupants of the front seats 30L, 30R and in most cases would favor the identity of the driver and so the customized playlist and radio selection of the driver would automatically be selected. However, as previously referred to, in some embodiments where there is common audio content in the respective playlists of the driver and the front seat passenger a composite playlist comprised of common audio content could be automatically selected or the occupants can be given the opportunity to choose between the driver and the passenger customized playlists.

Therefore, in summary, in accordance with this invention a motor vehicle entertainment system is operable to determine the front seat occupants using front seat position and mass sensors and use this information to select appropriate audio output.

Using a system constructed in accordance with this invention it is possible to create playlists quickly and easily within an entertainment unit of the entertainment system and save them for future use. The entertainment unit is operable to save multiple playlists and save them as customized playlists referenced by the identity of the individual who created them.

The entertainment unit is preferably able to recognize when a new audio item (song) has been added to a USB device and provide the option of adding the item to a playlist of a known occupant.

Also, if an audio item is repeatedly played and is not on a playlist the entertainment unit will automatically save it to a playlist of a known occupant.

The entertainment unit may further be operable to recognize a relationship between an occupant and a radio station and offer the selection of the radio station as an option.

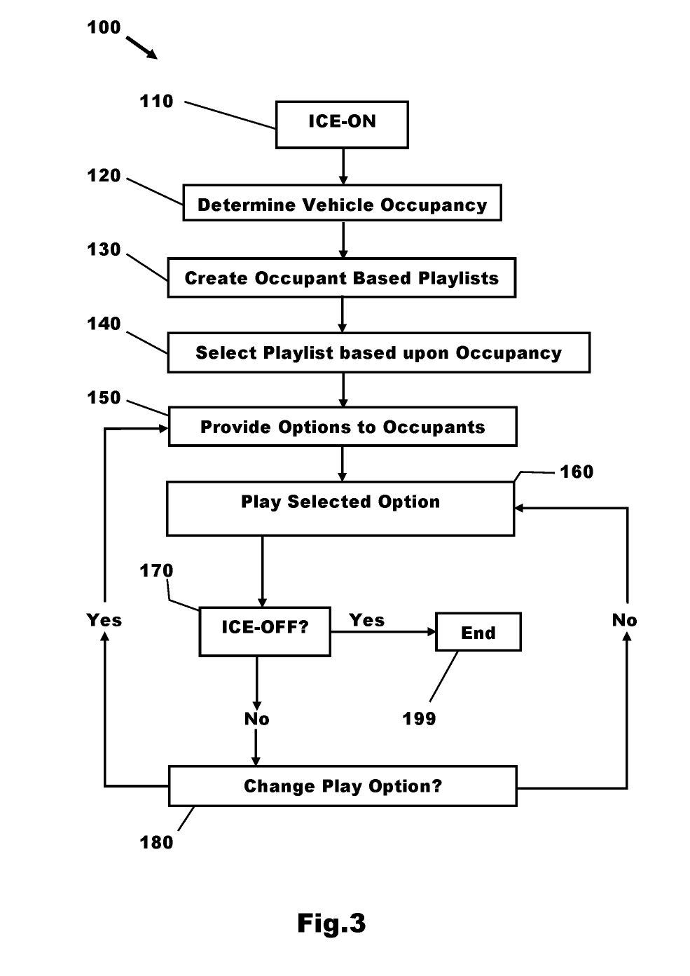

Referring now to FIG. 3, there is shown a high level flow chart of a method 100 of controlling a motor vehicle entertainment system in accordance with this invention that could be embodied as a number of executable steps in a programmable device such as the central control unit 24.

The method commences in box 110 where an entertainment system including an entertainment unit such as the entertainment unit 20 is switched on.

The method then advances to box 120 in which the occupancy of the motor vehicle is established based upon the use of one or more seat sensors. In a basic system, the fore-aft position of a seat for a driver is sensed using a seat position sensor and mass sensors are provide in both of the front seats. It will be appreciated that such mass sensors are often provided for use by a safety system of the motor vehicle to determine whether an airbag should be maintained in a de-activated or active state.

Although it would be possible to use only a seat position sensor or a mass sensor to establish the identity of a seat occupant, this can produce errors in occupant recognition because several occupants may be of similar weight or use a similar seat position. Therefore, it is desirable that both occupant weight sensing and fore-aft seat position sensors are provide for both of the front seats. Based upon the inputs received from the seat sensors an occupant identity is inferred.

Moving on from box 120 to box 130 customized playlists based upon occupants are created and saved on-board a motor vehicle such as the motor vehicle 1 in a memory device such as the memory device 25.

It will be appreciated that the action referred to in box 130 can take place at any time during a period when the entertainment unit is switched on. So, for example, when a particular audio item (song) is played by a particular occupant a number of times it will automatically be saved to the on-board memory of the entertainment unit 20 or a prompt can be provided asking whether such an audio item should be saved. As yet another example, if a music album is played via a USB device, wireless device or a compact disc player of the entertainment unit then the album will, provided such saving is legal in the country of use, be automatically saved to the on-board memory of the entertainment unit or a prompt can be provided asking whether the album should be saved. As yet a further alternative, when a particular radio station is selected by a particular occupant a number of times it can automatically be saved to the on-board memory or a prompt can be provided asking whether such a radio station should be saved.

In all cases, the respective occupant has to be first identified so that the respective playlist or radio station can be indexed or associated with that occupant.

Moving on to box 140 the identity of the occupant is then used to select either a customized playlist or a preferred radio station for the identified occupant depending upon the mode that the entertainment unit 20 is in. If the entertainment unit 20 is in a radio mode then the preferred radio station is automatically selected and an audio output from that radio station is provided to the speakers 21, 22. If the entertainment unit 20 is in a saved music mode then the relevant customized playlist is selected either automatically or via a prompt to the occupants.

Then, as indicated in box 150, in a case where more than one occupant has been identified, the occupants will be offered the option to choose from a number of customized playlists chosen to reflect the current occupancy of the motor vehicle.

In a case where there is a single occupant in the motor vehicle (a driver), a playlist associated with the driver will automatically be selected. The automatic selection of a preferred radio station for the driver may be provided or the occupant may be given the opportunity to select from radio or saved audio content on the customized playlist.

In a case where there are several occupants, then several playlists based upon the identities of the respective front seat occupants will be offered for selection by the occupants based upon the identity of the respective front seat occupants.

In some cases, the playlist selected may be the playlist associated with the driver of the motor vehicle and in other cases a composite playlist comprised of the playlist of the driver and the front seat passenger can be offered as options for selection.

Moving on from box 150, when a playlist or radio station has been selected it is played by the entertainment unit and then, in box 170, it is checked whether the entertainment unit is still switched on. If the entertainment unit is still on, then the selected audio output will continue to be played and the method advances to box 180 where a prompt is provided to a user of the entertainment system asking whether it is required to change the play option. That is to say, if there was the possibility of more than one playlist offered in box 150, the prompt asks whether the user now wishes to change the selection made in box 150.

If the answer to the question posed in box 180 is ‘Yes’ the method returns to box 150 and otherwise it returns to box 160 and the currently selected audio output continues to be played.

Referring back to box 170, if the entertainment unit is switched off at any time then the method ends in box 199.

Therefore in summary, the method automatically provides for selection either one or more playlists chosen to reflect the tastes of the current identified occupants, a playlist associated with the driver or automatically selects a playlist based upon the current occupancy of the motor vehicle.

It will be appreciated by those skilled in the art that although the invention has been described by way of example with reference to one or more embodiments it is not limited to the disclosed embodiments and that alternative embodiments could be constructed without departing from the scope of the invention as defined by the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of controlling a motor vehicle entertainment system comprising:
establishing an identity of one or more occupants of the vehicle; and
automatically selecting an audio output based upon the identity of the vehicle occupants.

2. The method of claim 1, wherein selecting an audio output based upon the identity of the vehicle occupants comprises providing for one of the identified occupants of the vehicle a customized playlist specific to that occupant.

3. The method of claim 1, wherein selecting an audio output based upon the identity of the vehicle occupants comprises automatically selecting for one of the identified occupants of the motor vehicle a preferred radio station based upon previous use of the radio by the identified occupant and producing an audio output from the automatically selected radio station.

4. The method of claim 1 wherein, the method further comprises saving, using at least one memory device, for an identified occupant of the vehicle a customized playlist for the identified occupant.

5. The method of claim 1, wherein establishing the identity of one or more occupants of the vehicle comprises using at least one of a seat fore-aft position sensor and a seat mass sensor to establish characteristics of an occupant of a seat and saving, via at least one memory device, the characteristics of the occupant of the seat as an occupant identity reference.

6. The method of claim 5 further comprising selecting from a number of saved playlists a customized playlist based upon the established identity of the one or more occupants and providing the one or more occupants of the vehicle with the customized playlist.

7. The method of claim 1 further comprising using at least one of a seat fore-aft position sensor and a seat mass sensor to establish the identity of a driver of the vehicle, automatically selecting from a number of saved playlists a customized playlist based upon the identity of the driver and automatically providing an audio output from the automatically selected customized playlist.

8. The method of claim 1 further comprising using at least one of a seat fore-aft position sensor and a seat mass sensor to establish the identity of a driver of the vehicle and automatically selecting a driver preferred radio station based upon previous use of the radio by the driver and producing an audio output from the automatically selected radio station.

9. A vehicle entertainment system comprising:
an entertainment unit arranged to provide an audio output and including a programmable device arranged to establish, based upon one or more sensor inputs, the identity of an occupant and select an audio output based upon the identified occupant; and
an interface operatively connected to the unit such that the interface is configured to play the selected audio output, provided to the interface by the unit.

10. The system of claim 9, wherein the sensor inputs include an input from a seat fore-aft position sensor and a seat mass sensor.

11. The system of claim 9, wherein the sensor inputs include an input from a seat fore-aft position sensor or a seat mass sensor.

12. The system of claim 9, wherein the sensor inputs are associated with a driver.

13. The system of claim 9, wherein the sensor inputs are associated with a passenger.

14. The system of claim 9, wherein a seat for a driver includes a seat fore-aft position sensor and a seat mass sensor and the identity of the driver is established based upon the outputs from the seat fore-aft position and mass sensors.

15. A vehicle comprising:
a seat having a sensor disposed within the seat and being configured to sense an occupant; and
an entertainment system having a human machine interface and including a unit operatively connected to the sensor and an audio device such that in response to the sensor indicating a presence of the occupant, the unit provides an audio output to the human machine interface, wherein the audio output depends on an identity of the occupant established via the sensor.

16. The vehicle of claim 15, wherein the audio output comprises a customized playlist specific to the occupant.

17. The vehicle of claim 15, wherein the sensor is disposed within a seat of the vehicle and is configured to identify the occupant using a fore-aft seat position.

18. The vehicle of claim 15, wherein the sensor is disposed within a seat of the vehicle and is configured to identify the occupant using a mass of the occupant.

19. The vehicle of claim 15, wherein the audio output comprises a preferred radio station specific to the occupant.

20. The vehicle of claim 15, wherein the audio output comprises a number of customized playlists based on the identified occupant.
